(19) United States
(12) Patent Application Publication
(10) Pub. No.: US 2020/0074780 A1
(43) Pub. Date: Mar. 5, 2020

(54) MONEY PROCESSING APPARATUS

(71) Applicant: FUJI ELECTRIC CO., LTD., Kawasaki-shi (JP)

(72) Inventors: Norihiko TANAAMI, Tokyo (JP); Yoshihiro TANIGUCHI, Yokkaichi-city (JP); Yoshito SHIBATA, Tsu-city (JP); Kazuya CHIKUNI, Matsumoto-city (JP)

(21) Appl. No.: 16/547,949

(22) Filed: Aug. 22, 2019

(30) Foreign Application Priority Data
Aug. 31, 2018 (JP) 2018-163682

(51) Int. Cl. G07D 3/14; G07D 3/16

(52) U.S. Cl. CPC G07D 3/14; G07D 3/16; G07D 1/06; G07D 2201/00; G07D 2205/00

(57) ABSTRACT

A money processing apparatus includes: a coin sorter configured to sort a received coin by denominations; coin storages each provided for each denomination, each of the coin storages being configured to store the coin sorted by the coin sorter and deliver the coin in accordance with a payment instruction; a conveyor configured to convey coins one by one such that the coins do not overlap with each other; and a count detector configured to detect the number of coins conveyed by the conveyor, wherein a passing speed of the coin in a detection area of the count detector is greater than a passing speed of the coin immediately before the detection area of the count detector.

The present application claims priority to and incorporates by reference the entire contents of Japanese Patent Application No. 2018-163682 filed in Japan on Aug. 31, 2018.

### BACKGROUND

The present disclosure relates to a money processing apparatus.

For example, in general, in a shop such as a supermarket and a convenience store, a money processing apparatus serving as an automatic change machine is connected to a point of sales (POS) terminal. The money processing apparatus identifies a received coin that is deposited into a coin deposit port, sorts the coin identified as a genuine coin in accordance with denominations at a coin sorting unit, and stores by denomination the sorted coin in a coin storage chamber provided for each denomination. When a payment command, which is a change dispensing request, is supplied from the POS terminal, the money processing apparatus causes the corresponding coin storage chamber to deliver the coin corresponding to the requested amount, conveys the coin to the coin payment port by the payment money conveying unit, and dispenses the coin (for example, see Japanese Laid-open Patent Publication No. 2016-71662).

In the money processing apparatus described above, a plurality of the coins are placed on and conveyed one by one by a conveyance belt or the like so that the coins do not overlap with each other, and the number of coins is detected during the conveyance.

However, when the coins are conveyed, even though the coins do not overlap with each other, the coins are sometimes continuously conveyed in a manner like a string of beads. This makes it difficult to detect the number of coins.

There is a need for a money processing apparatus capable of detecting the number of coins to be conveyed.

### SUMMARY

In some embodiments, a money processing apparatus includes: a coin sorter configured to sort a received coin by denominations; coin storages each provided for each denomination, each of the coin storages being configured to store the coin sorted by the coin sorter and deliver the coin in accordance with a payment instruction; a conveyor configured to convey coins one by one such that the coins do not overlap with each other; and a count detector configured to detect the number of coins conveyed by the conveyor, wherein a passing speed of the coin in a detection area of the count detector is greater than a passing speed of the coin immediately before the detection area of the count detector.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a plan view illustrating a configuration of a money processing apparatus of an embodiment;

FIG. 2 is a block diagram illustrating a characteristic control system of the money processing apparatus of the embodiment;

FIG. 3 is a front view illustrating a configuration of a coin processing machine illustrated in FIG. 1 and FIG. 2;

FIG. 4 is a schematic diagram schematically illustrating the internal structure of the coin processing machine illustrated in FIG. 1 and FIG. 2;

FIG. 5 is a perspective view illustrating a configuration of a coin return and discharge unit illustrated in FIG. 4;

FIG. 6 is a plan view illustrating a configuration of the coin return and discharge unit illustrated in FIG. 4;

FIG. 7 is a sectional view cut along a line A-A in FIG. 6;

FIG. 8 is a longitudinal sectional view schematically illustrating a way that a coin is passing through a coin return passage in the coin return and discharge unit illustrated in FIG. 5 to FIG. 7;

FIG. 9 is a longitudinal sectional view schematically illustrating a way that a coin is passing through a coin discharge passage in the coin return and discharge unit illustrated in FIG. 5 to FIG. 7;

FIG. 10 is a front view of a bill processing machine illustrated in FIG. 1;

FIG. 11 is a sectional view schematically illustrating a configuration of the bill processing machine illustrated in FIG. 1;

FIG. 12 is an enlarged perspective view illustrating an enlarged bill receiving port of the bill processing machine illustrated in FIG. 10 and FIG. 11;

FIG. 13 is a flowchart illustrating processing contents of a discharge control process of overflow coins performed by a cash control unit illustrated in FIG. 2; and

FIG. 14 is a longitudinal sectional view illustrating an enlarged bill receiving port of the bill processing machine illustrated in FIG. 10 and FIG. 11.

### DETAILED DESCRIPTION

Hereinafter, a preferred embodiment of a money processing apparatus according to the present disclosure will be described in detail with reference to the accompanying drawings.

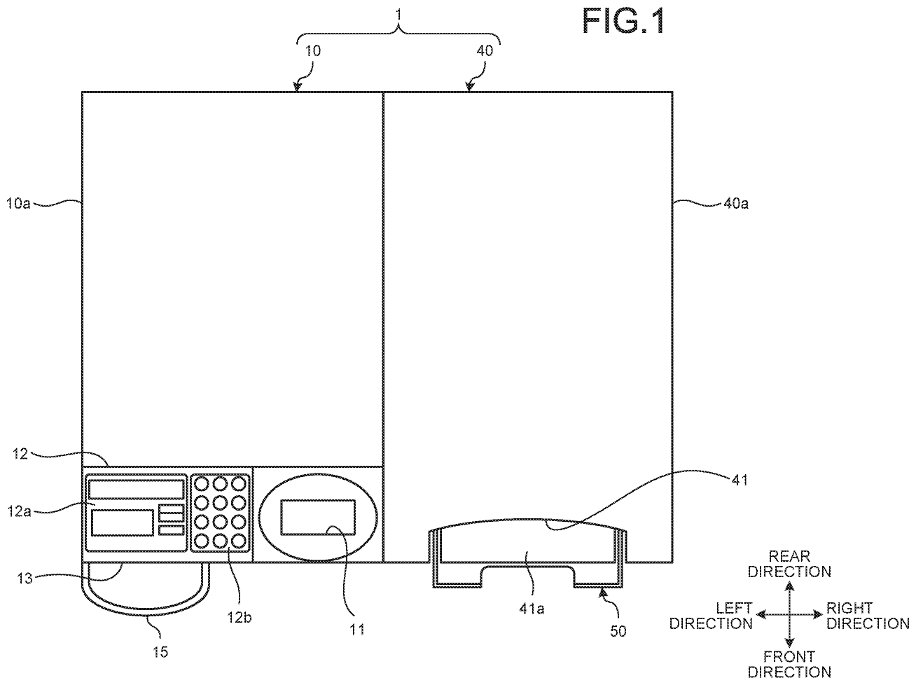

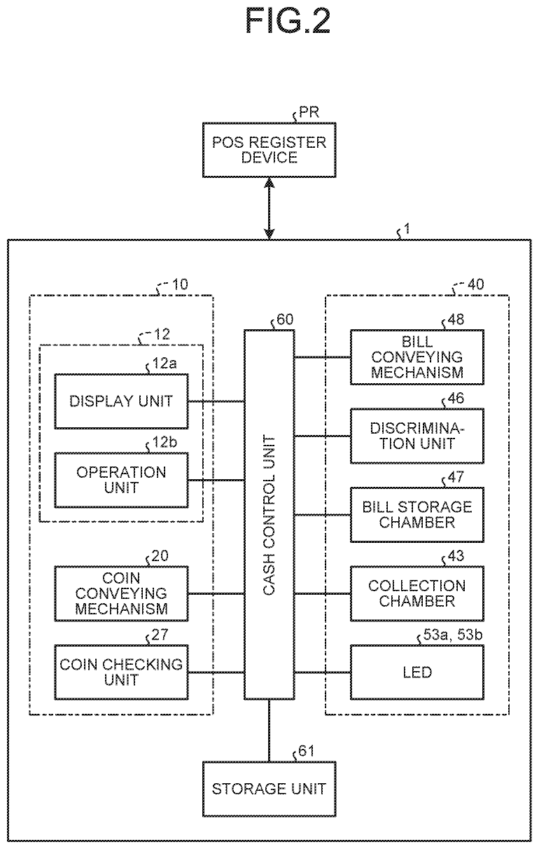

FIG. 1 and FIG. 2 each illustrate a money processing apparatus of an embodiment. FIG. 1 is a plan view illustrating a configuration of the money processing apparatus. FIG. 2 is a block diagram illustrating a characteristic control system of the money processing apparatus.

For example, in a shop such as a supermarket and a convenience store, a money processing apparatus 1 illustrated in this example is applied as an automatic change machine connected to a point of sales (POS) register device PR serving as a host device. The money processing apparatus 1 includes a coin processing machine 10, a bill processing machine 40, and a cash control unit 60.

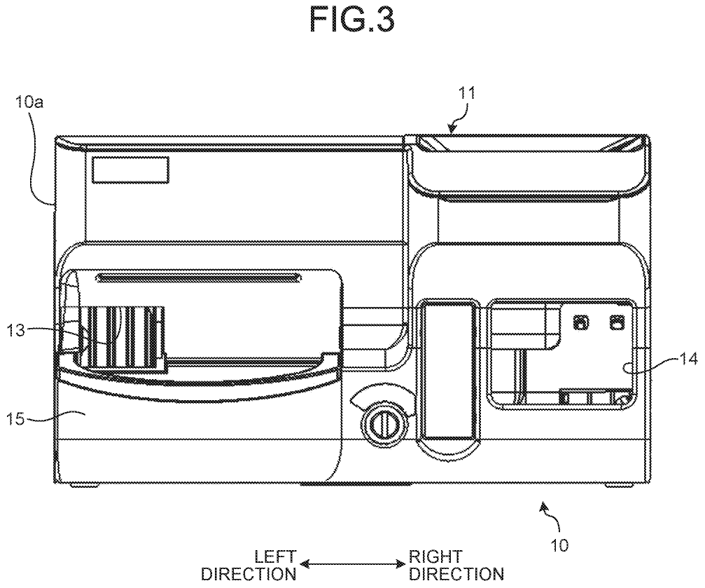

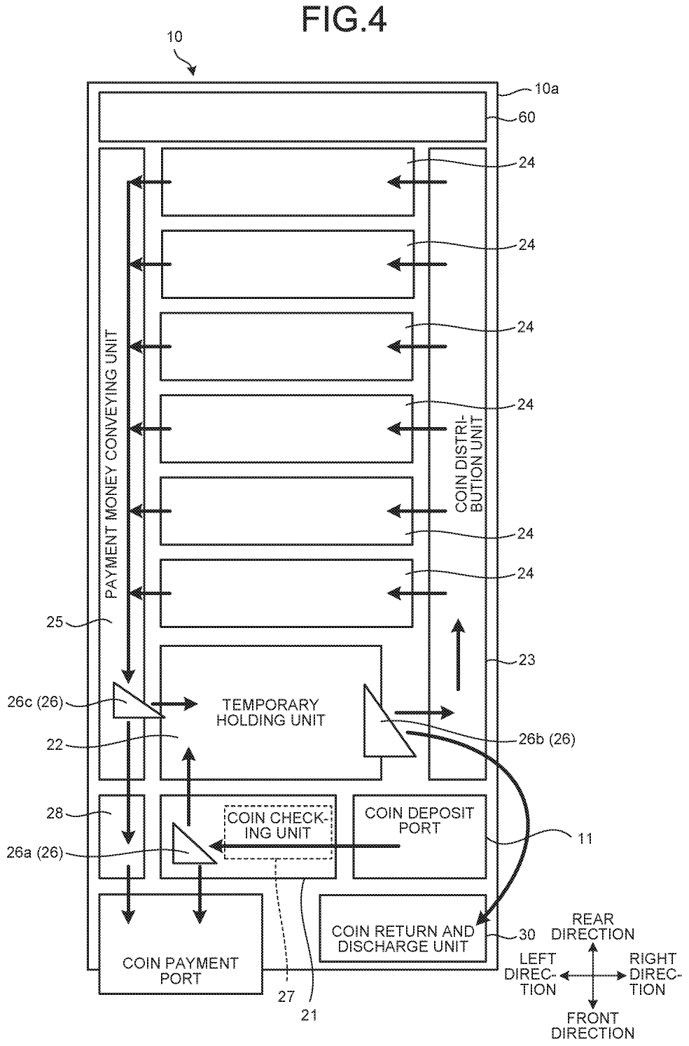

FIG. 3 and FIG. 4 each illustrate the coin processing machine 10 illustrated in FIG. 1 and FIG. 2. FIG. 3 is a front view illustrating a configuration of the coin processing machine 10. FIG. 4 is a schematic diagram schematically illustrating the internal structure of the coin processing machine 10.

As illustrated in FIG. 3 and FIG. 4, the coin processing machine 10 includes a coin processing machine main body 10a, which is a casing formed in a substantially parallelepiped shape. The coin processing machine main body 10a is provided with a coin deposit port 11, an operation display unit 12, a coin payment port 13, and a coin return port 14.

The coin deposit port 11 is provided at the right hand side on the upper surface of the front end of the coin processing machine main body 10a. The coin deposit port 11 is an opening for receiving a deposited coin into the coin processing machine main body 10a. For example, the coin deposit port 11 functions as a temporary holding part that temporarily holds the deposit money from a user such as a customer.

The operation display unit 12 is provided at the left hand side on the upper surface of the front end of the coin processing machine main body 10a. The operation display unit 12 includes a display unit 12a and an operation unit 12b. The display unit 12a displays various types of information. The operation unit 12b is an input unit configured of, for example, a numeric keypad and the like so as to perform various operation inputs.

The coin payment port 13 is provided at the left hand side on the front surface of the coin processing machine main body 10a. The coin payment port 13 is an opening for dispensing the coin stored inside the coin processing machine main body 10a. The coin payment port 13 dispenses the coin onto a payment tray 15 fitted to the coin processing machine main body 10a. The coin return port 14 is provided at the right hand side on the front surface of the coin processing machine main body 10a. The coin return port 14 is an opening for returning a coin.

A coin conveying mechanism 20 is provided inside the coin processing machine main body 10a. The coin conveying mechanism 20 includes a received money conveying unit 21, a temporary holding unit 22, a coin sorting unit 23, coin storage chambers 24, a payment money conveying unit 25, and a switch gate group 26.

The received money conveying unit 21 conveys a coin that is deposited into the coin deposit port 11 and that is detected by a deposit detection sensor, which is not illustrated. The received money conveying unit 21 is provided with a coin checking unit 27. The coin checking unit 27 determines the authenticity and denomination of the coin.

The temporary holding unit 22 temporarily holds the coin determined to be a genuine coin by the coin checking unit 27. The coin sorting unit 23 sorts the coin that is held by the temporary holding unit 22 and that is then conveyed, in accordance with denominations.

The coin storage chambers 24 are provided in accordance with denominations, and each store therein the coin sorted by the coin sorting unit 23. The coin storage chambers 24 individually store therein the deposited coin by denomination. Moreover, each coin storage chamber 24 has a function for delivering the stored coin.

The payment money conveying unit 25 conveys the coin delivered from the coin storage chamber 24 forward. In other words, the payment money conveying unit 25 conveys the coin delivered from the coin storage chamber 24 toward a payment shoot 28 that is communicated with the coin payment port 13.

The switch gate group 26 includes a first switch gate 26a, a second switch gate 26b, and a third switch gate 26c. The first switch gate 26a is provided at the downstream side in the conveying direction of the received money conveying unit 21. The first switch gate 26a is capable of alternately switching between a state in which the coin conveyed by the received money conveying unit 21 is conveyed to the temporary holding unit 22, and a state in which the coin is conveyed to the coin payment port 13.

The second switch gate 26b is provided at the downstream side in the conveying direction of the temporary holding unit 22. The second switch gate 26b is capable of alternately switching between a state in which the coin held in the temporary holding unit 22 is sent to the coin sorting unit 23, and a state in which the coin is sent to a coin return and discharge unit 30, which will be described below. In a normal condition, the state of the second switch gate 26b described above is such that the coin held in the temporary holding unit 22 is to be sent to the coin sorting unit 23.

It is to be noted that a reverse roller, which is not illustrated, conveys the coins held in the temporary holding unit 22 one by one so that the coins do not overlap with each other, when the coins are conveyed to the coin sorting unit 23 or the coin return and discharge unit 30, by a conveyance unit (not illustrated) such as a conveyance belt and a conveyance roller. Moreover, the coin is conveyed in a sideways posture, in other words, a posture in which the center axis of the coin is substantially perpendicular to the conveying direction.

The third switch gate 26c is provided at the downstream side in the conveying direction of the payment money conveying unit 25. The third switch gate 26c is capable of alternately switching between a conveyance state in which the coin conveyed by the payment money conveying unit 25 is conveyed to the coin payment port 13 via the payment shoot 28 and a circulation state in which the coin is conveyed to the temporary holding unit 22. In a normal state, the third switch gate 26c described above is in the conveyance state.

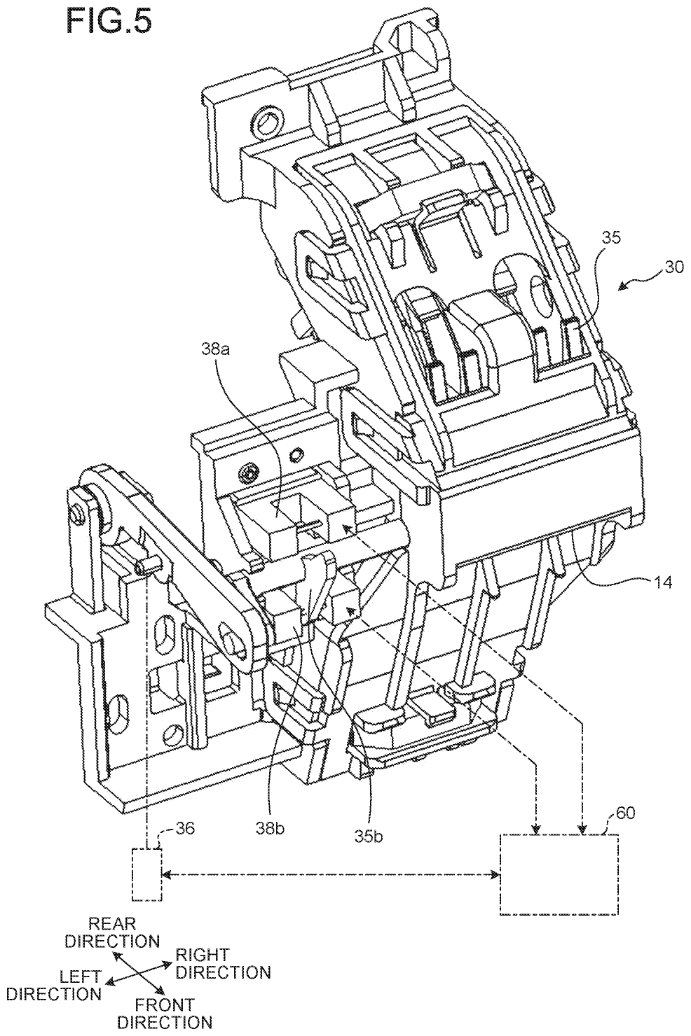

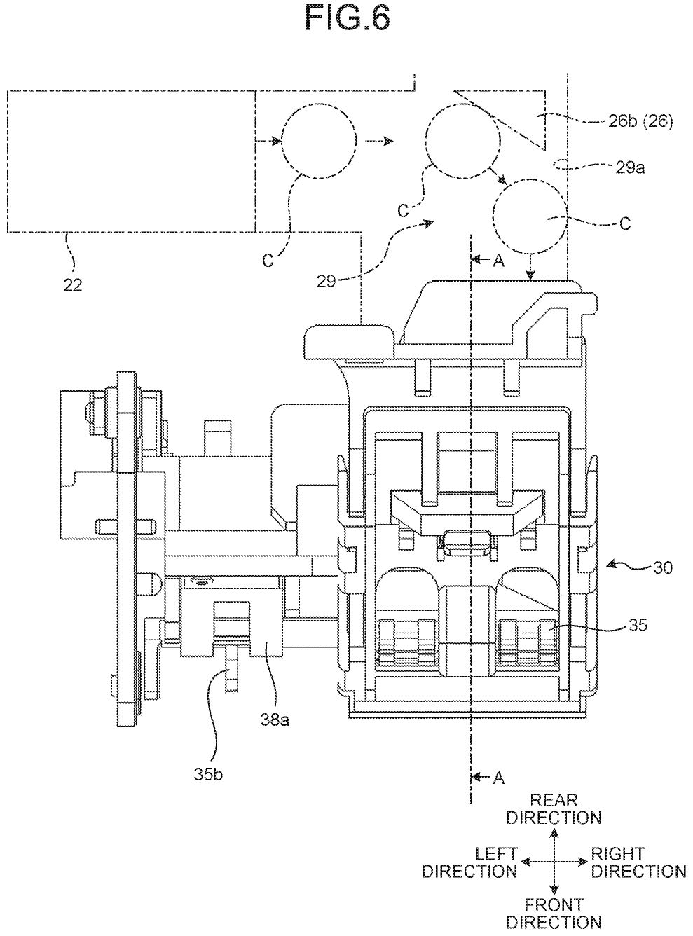

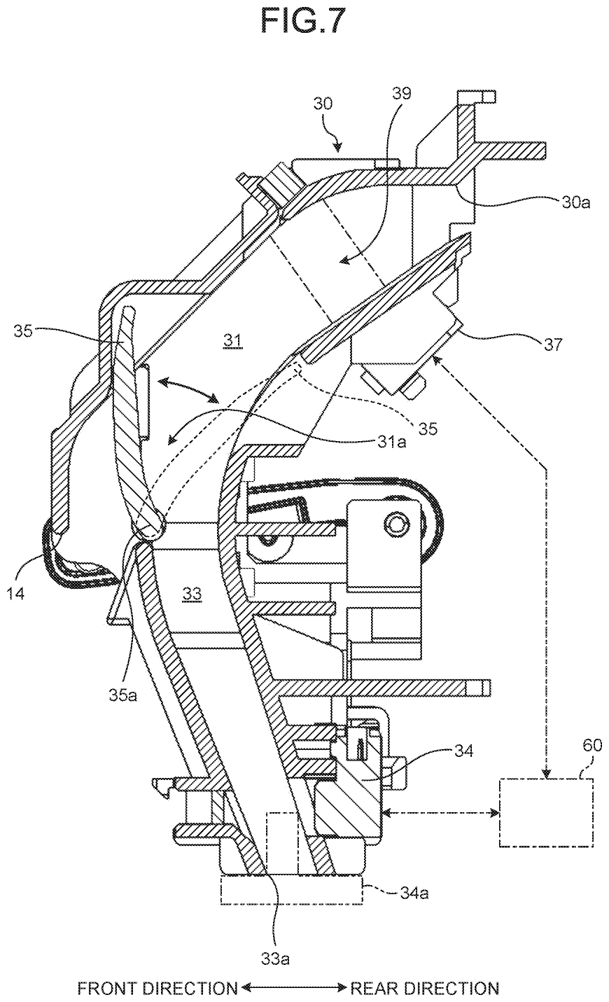

FIG. 5 to FIG. 7 each illustrate the coin return and discharge unit 30 illustrated in FIG. 4. FIG. 5 is a perspective view illustrating a configuration of the coin return and discharge unit 30. FIG. 6 is a plan view illustrating a configuration of the coin return and discharge unit 30. FIG. 7 is a sectional view cut along a line A-A in FIG. 6.

The coin return and discharge unit 30 illustrated in FIG. 5 to FIG. 7 configures the coin conveying mechanism 20 described above. The coin return and discharge unit 30 is provided with a coin return passage 31, a coin discharge passage 33, a coin return and discharge gate (gate member) 35, and a count detecting unit 37.

To the coin return and discharge unit 30 described above, a coin C is introduced from a unit inlet 30a. The coin C is first abutted to the second switch gate 26b after being conveyed in the right direction from the temporary holding unit 22 by the conveyance unit, and is conveyed forward after coming into contact with a wall surface 29a of a conveyance passage 29 and the direction of which is changed.

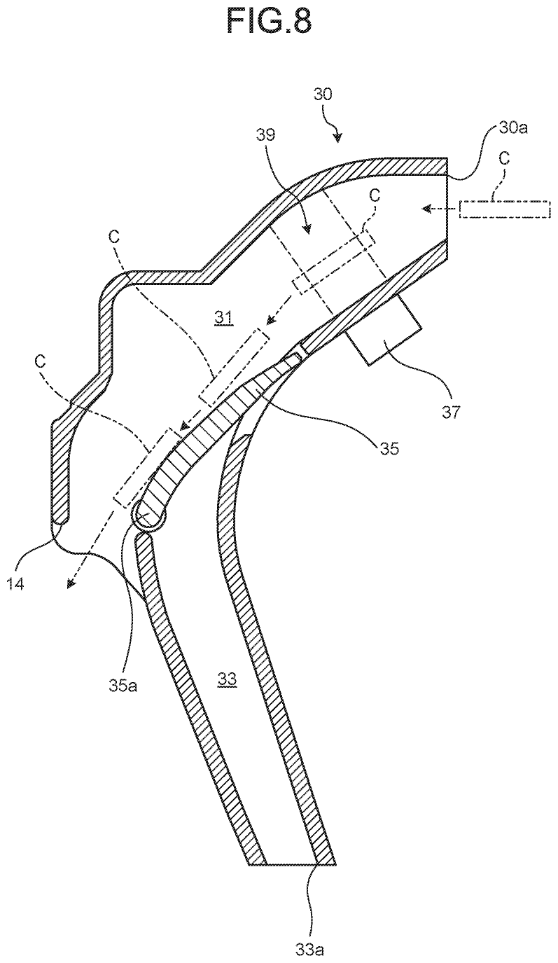

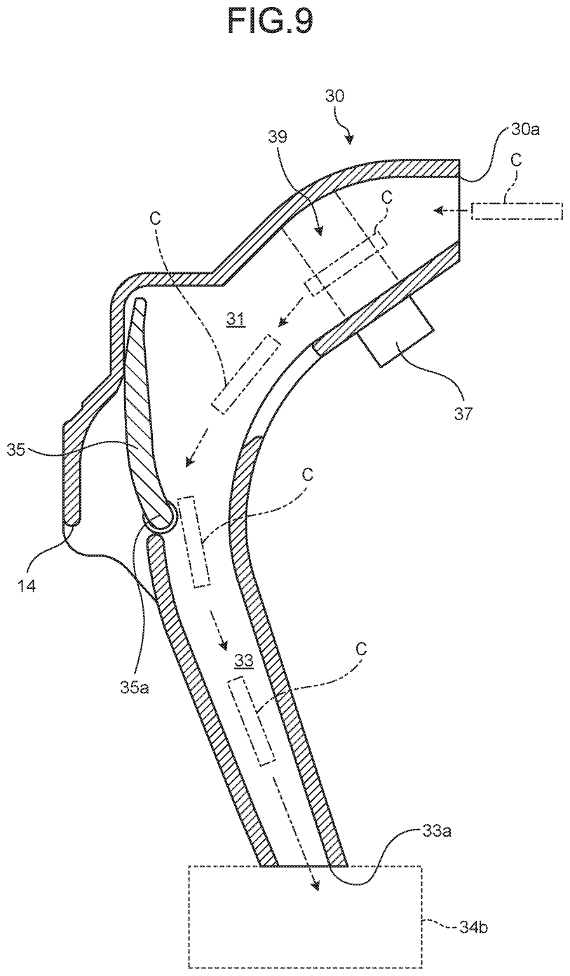

The coin return passage 31 is formed so as to gradually incline downward from the unit inlet 30a toward the front direction, and is communicated with the coin return port 14. As illustrated in FIG. 8 and FIG. 9, the coin return passage 31 is inclined and extended downward so that the coin C introduced from the unit inlet 30a can fall freely immediately after the introduction, due to the unbalanced center of gravity of the coin C.

The coin discharge passage 33 is formed so as to be branched from a branch point 31a placed in the midway of the coin return passage 31, and the rear side of the coin return passage 31 is extended downward. A coin discharge port 33a is provided on the lower end portion of the coin discharge passage 33. Although not illustrated, this coin discharge port 33a is opened on the bottom surface of the coin processing machine main body 10a.

In this example, an open and close detecting unit 34 is provided near the lower end part of the coin discharge passage 33. This open and close detecting unit 34 detects the opening and closing of the coin discharge port 33a. When the coin discharge port 33a is closed by a lid body 34a, the open and close detecting unit 34 supplies a detection signal indicating such to the cash control unit 60. Alternatively, when the coin discharge port 33a is opened, the open and close detecting unit 34 supplies a detection signal indicating such to the cash control unit 60. When the coin discharge port 33a is opened, it is assumed that a coin collection bag 34b is installed so as to cover the coin discharge port 33a.

At the branch point 31a of the coin return passage 31 and the coin discharge passage 33, the coin return and discharge gate 35 is swingably provided along the longitudinal direction around the center axis of a gate axis part 35a that extends along the horizontal direction. By swinging along the longitudinal direction, the coin return and discharge gate 35 is capable of alternately switching between a first state in which the coin C that has circulated to the coin return passage 31 from the temporary holding unit 22 through the unit inlet 30a is passed toward the coin return port 14 (the state illustrated by the broken line in FIG. 7, and the state illustrated in FIG. 8), and a second state in which the coin C that has circulated to the coin return passage 31 from the temporary holding unit 22 through the unit inlet 30a is passed through the coin discharge passage 33 from the branch point 31a (the state illustrated by the actual line in FIG. 7, and the state illustrated in FIG. 9).

In a normal state, the coin return and discharge gate 35 is held in the first state by an energization unit, which is not illustrated. When an actuator 36 such as a solenoid, which is driven according to a command from the cash control unit 60, is driven, the coin return and discharge gate 35 is turned into a second state by swinging forward against the energization force of the energization unit. In other words, the coin return and discharge gate 35 is capable of alternately switching between the first state and the second state according to a command supplied from the cash control unit 60.

A reference numeral 38a and a reference numeral 38b in FIG. 5 indicate a first state detection unit and a second state detection unit that each detect the state of the coin return and discharge gate 35. The first state detection unit 38a configured, for example, by an optical sensor turns ON when the coin return and discharge gate 35 is in the first state, with the light from the light emitting unit being blocked by a light shielding plate 35b fitted to the coin return and discharge gate 35, and sends an ON signal to the cash control unit 60. The second state detection unit 38b configured, for example, by an optical sensor turns ON when the coin return and discharge gate 35 is in the second state, with the light from the light emitting unit being blocked by the light shielding plate 35b fitted to the coin return and discharge gate 35, and sends an ON signal to the cash control unit 60.

The count detecting unit 37 is installed near a location closer to the unit inlet 30a than the branch point 31a of the coin return passage 31. A detection area 39 is an area through which the coin C that is introduced from the unit inlet 30a passes by free fall due to the unbalanced center of gravity of the coin C. The count detecting unit 37 detects the number of the coin C that passes through the detection area 39, and supplies the detection result to the cash control unit 60.

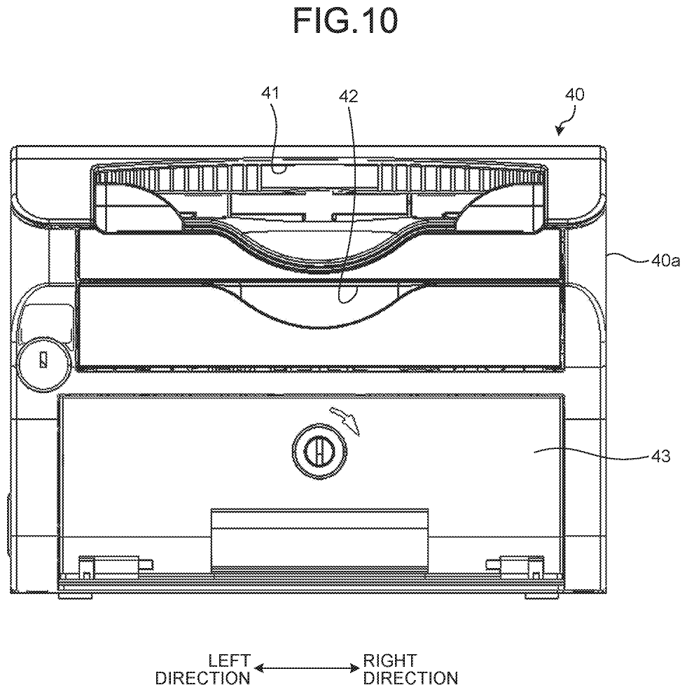

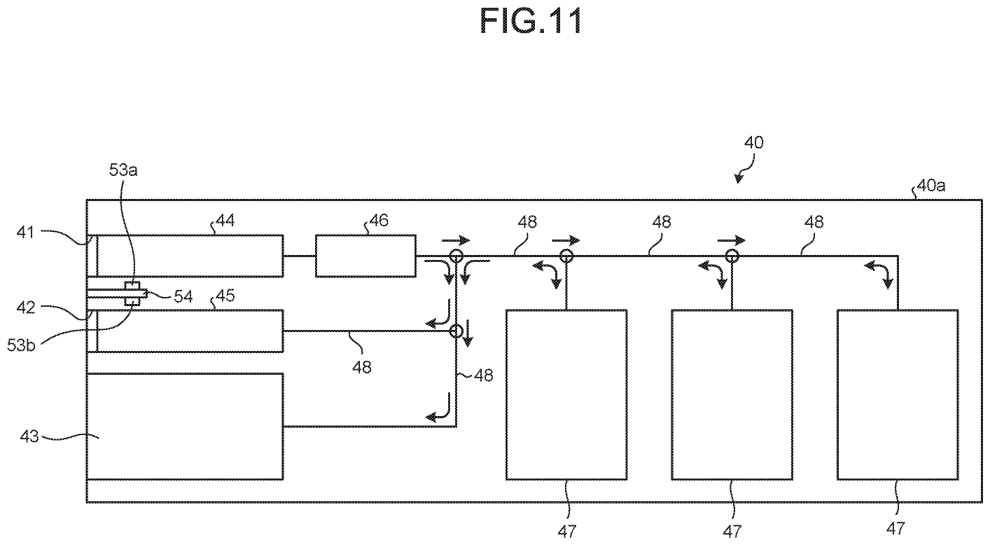

FIG. 10 and FIG. 11 each illustrate the bill processing machine 40 illustrated in FIG. 1. FIG. 10 is a front view of the bill processing machine 40. FIG. 11 is a sectional view schematically illustrating a configuration of the bill processing machine 40.

The bill processing machine 40 illustrated in this example is disposed beside the coin processing machine 10. In the bill processing machine 40, a bill receiving port 41 for depositing bill, and a bill payment port 42 from which the stored bill is dispensed as change are formed on the front surface of a bill processing machine main body 40a that is a casing formed substantially in a rectangular parallelepiped shape. Moreover, the front surface part of a collection chamber 43 that can be pulled out is exposed from a lower part of the front surface of the bill processing machine main body 40a.

The bill processing machine 40 described above includes a money receiving unit 44, a money payment unit 45, the collection chamber 43, a discrimination unit 46, and bill storage chambers 47. The money receiving unit 44 introduces a bill deposited into the bill receiving port 41 inside the device. The money payment unit 45 delivers the bill to the bill payment port 42. The discrimination unit 46 determines the authenticity and denomination of the bill. The bill storages chamber 47 each store therein the bill in accordance with denominations. The money receiving unit 44, the money payment unit 45, the collection chamber 43, the discrimination unit 46, and the bill storage chambers 47 described above are connected by a bill conveying mechanism 48.

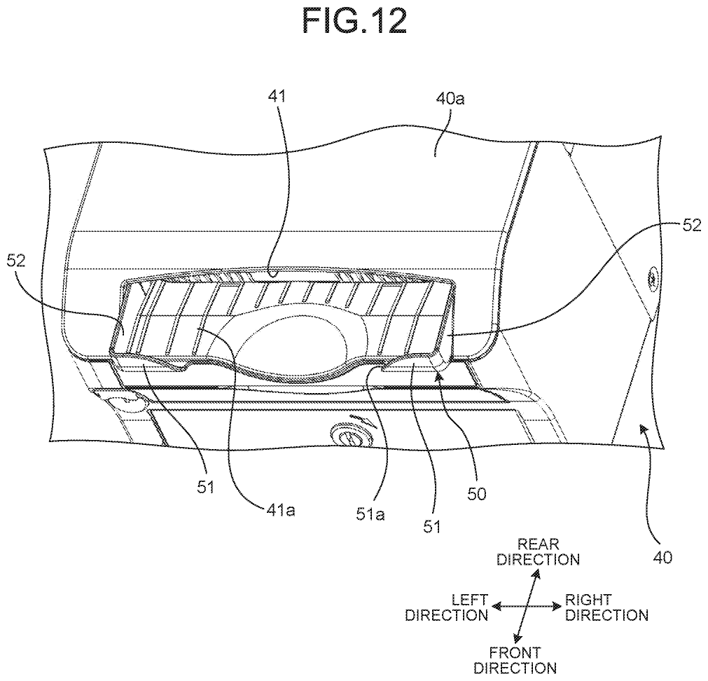

As illustrated in FIG. 12, at the bill receiving port 41 that configures the money receiving unit 44 described above, a bottom part 41a that configures the bill receiving port 41 is formed so as to project forward with respect to the bill receiving port 41. The bill is placed on the bottom part 41a described above.

A bill guide 50 is provided on the bottom part 41a described above. For example, the bill guide 50 is formed of a resin material, and includes an upward extending part 51 and a side extending part 52.

The upward extending part 51 extends upward from the front end portion of the bottom part 41a, and is a long portion the horizontal direction of which is the longitudinal direction. A notch 51a is formed on the center portion of the upward extending part 51 in the horizontal direction. The side extending part 52 continues to the right end part and the left end part of the upward extending part 51. The side extending part 52 is provided so as to project upward from the right end portion and the left end portion of the bottom part 41a.

The money receiving unit 44 described above and the money payment unit 45 described above are provided so as to be adjacent to each other in the vertical direction. A substrate 54 is mounted in a portion that divides the money receiving unit 44 and the money payment unit 45. Light-emitting diodes (LEDs) 53a and 53b, which are light sources, are provided on the upper surface and the lower surface of the substrate 54. The LED 53a provided on the upper surface of the substrate 54 illuminates an edge portion including the bill guide 50, by emitting the bottom part 41a that configures the bill receiving port 41. The LED 53b provided on the lower surface of the substrate 54 illuminates the bill payment port 42 by emitting the money payment unit 45.

The cash control unit 60 is a control unit that integrally controls the operations of the units in the coin processing machine 10 and the units in the bill processing machine 40 according to a computer program and data stored in a storage unit 61. For example, the cash control unit 60 may be implemented by causing a processing device such as a central processing unit (CPU) to execute a computer program, in other words, by software. Alternatively, the cash control unit 60 may be implemented by hardware such as an integrated circuit (IC), or by any combination of software and hardware.

The operation of the money processing apparatus 1 having the configuration as described above will now be described. First, the operation of the coin processing machine 10 will be described.

A coin deposited into the coin deposit port 11, upon receipt of a received money authorization command from the POS register device PR, is detected by an insertion detection sensor. Then, the coin is conveyed by the received money conveying unit 21, and the authenticity and denomination of the coin are determined by the coin checking unit 27. When the conveyed coin is a genuine coin, the coin is held in the temporary holding unit 22. On the other hand, when the conveyed coin is not a genuine coin, the coin is conveyed to the coin payment port 13 via the first switch gate 26a, and is returned to the payment tray 15.

The coin held in the temporary holding unit 22 is conveyed to the coin sorting unit 23, and is sorted in accordance with denominations while being conveyed in the rear direction. The coin sorted by the coin sorting unit 23 is stored in the coin storage chamber 24 according to the denomination.

When a payment command is supplied from the POS register device PR, the coin of the denomination according to the payment command is delivered from any coin storage chamber 24, and is conveyed forward by the payment money conveying unit 25. The coin is then dispensed to the outside of the coin processing machine main body 10a from the coin payment port 13 via the third switch gate 26c.

When a return instruction is supplied from the POS register device PR while the coin is held in the temporary holding unit 22, the coin is sent to the coin return and discharge unit 30 via the second switch gate 26b.

As described above, in the coin return and discharge unit 30, the coin return and discharge gate 35 is held in the first state in a normal state. Consequently, as illustrated in FIG. 8, the coin sent to the coin return and discharge unit 30 is introduced to the coin return passage 31 from the unit inlet 30a, passes through the coin return passage 31, and is dispensed from the coin return port 14.

The coin introduced from the unit inlet 30a is first abutted to the second switch gate 26b after being conveyed in the right direction from the temporary holding unit 22 by the conveyance unit. The coin is then conveyed forward after coming into contact with the wall surface 29a of the conveyance passage 29 and the direction of which is changed. Consequently, the coin passes through the unit inlet 30a while being decelerated by coming into contact with the wall surface 29a.

Because the coin return passage 31 is extended in such a manner, the coin that has passed through the unit inlet 30a passes through the detection area 39 of the count detecting unit 37 by free fall due to the unbalanced center of gravity of the coin. Consequently, the passing speed of the coin in the detection area 39 of the count detecting unit 37 is greater than the passing speed of the coin at the unit inlet 30a placed immediately before the detection area 39.

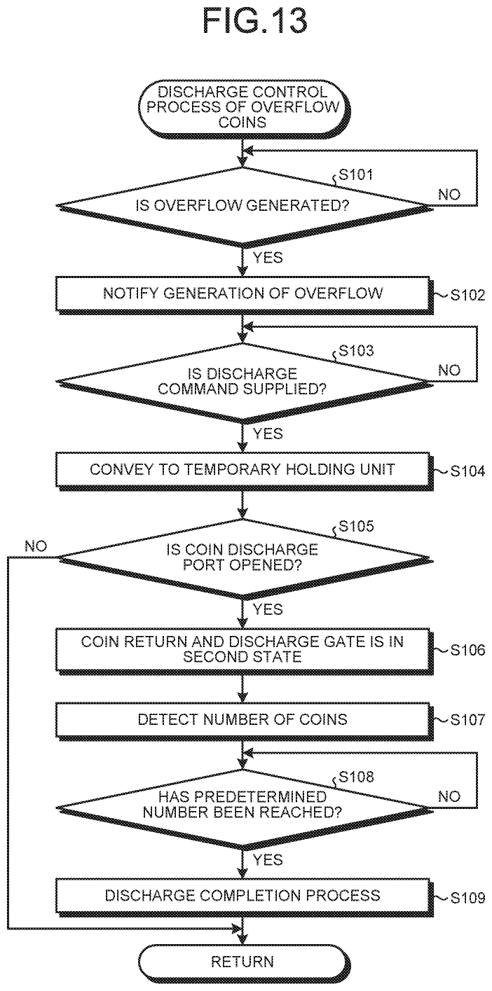

FIG. 13 is a flowchart illustrating processing contents of a discharge control process of overflow coins performed by the cash control unit 60 illustrated in FIG. 2. The operation of the coin processing machine 10 will now be described while explaining the processing contents of the discharge control process of overflow coins.

In the discharge control process of overflow coins, the cash control unit 60 determines whether the number of coins stored in the coin storage chamber 24 is equal to or more than a predetermined number of coins in any coin storage chamber 24 and overflow is generated (step S101).

When overflow is generated in any one of the coin storage chambers 24 (Yes at step S101), the cash control unit 60 notifies the POS register device PR that the overflow is generated (step S102). The cash control unit 60 then waits for a discharge command from the POS register device PR (step S103).

On the other hand, when overflow is not generated in any coin storage chamber 24 (No at step S101), the cash control unit 60 repeats the process at step S101.

When a discharge command of a predetermined number of coins is supplied from the POS register device PR (Yes at step S103), the cash control unit 60 causes the corresponding coin storage chamber 24 to deliver the predetermined number of coins, and causes the payment money conveying unit 25 to convey the coins to the temporary holding unit 22 (step S104).

Then, the cash control unit 60 determines whether the coin discharge port 33a is opened through the open and close detecting unit 34 (step S105). When the coin discharge port 33a is closed (No at step S105), in other words, when the coin discharge port 33a is closed by the lid body 34a, the cash control unit 60 does not perform the process described below, returns the procedure, and finishes this process.

When the coin discharge port 33a is opened (Yes at step S105), in other words, when the coin collection bag 34b is appropriately fitted to the coin discharge port 33a, the cash control unit 60 drives the actuator 36, and turns the coin return and discharge gate 35 into the second state (step S106).

Then, the coin held in the temporary holding unit 22 is sent to the coin return and discharge unit 30 via the second switch gate 26b. The number of coins is detected by passing the coin through the detection area 39 of the count detecting unit 37 from the unit inlet 30a (step S107). The coin that has passed through the detection area 39 reaches the coin discharge passage 33 at the branch point 31a, passes through the coin discharge passage 33, and is discharged to the outside (coin collection bag 34b) from the coin discharge port 33a.

The coin introduced from the unit inlet 30a is first abutted to the second switch gate 26b after being conveyed in the right direction from the temporary holding unit 22 by the conveyance unit. The coin is then conveyed forward after coming into contact with the wall surface 29a of the conveyance passage 29 and the direction of which is changed. Consequently, the coin passes through the unit inlet 30a while being decelerated by coming into contact with the wall surface 29a. Because the coin return passage 31 is extended in such a manner, the coin that has passed through the unit inlet 30a passes through the detection area 39 of the count detecting unit 37 by free fall due to the unbalanced center of gravity of the coin. Consequently, the passing speed of the coin in the detection area 39 of the count detecting unit 37 is greater than the passing speed of the coin at the unit inlet 30a placed immediately before the detection area 39.

The cash control unit 60 that performs the process at step S107 described above determines whether the number of coins detected by the count detecting unit 37 reaches a predetermined number of coins in the discharge command (step S108). When the number of coins detected by the count detecting unit 37 does not reach the predetermined number of coins (No at step S108), the cash control unit 60 repeats the process at step S107.

On the other hand, when the number of coins detected by the count detecting unit 37 reaches the predetermined number of coins (Yes at step S108), the cash control unit 60 performs a discharge completion process (step S109) such as stop driving the actuator 36, change the posture of the second switch gate 26b, stop driving the conveyance unit, and the like. Then, the cash control unit 60 returns the procedure, and finishes this process.

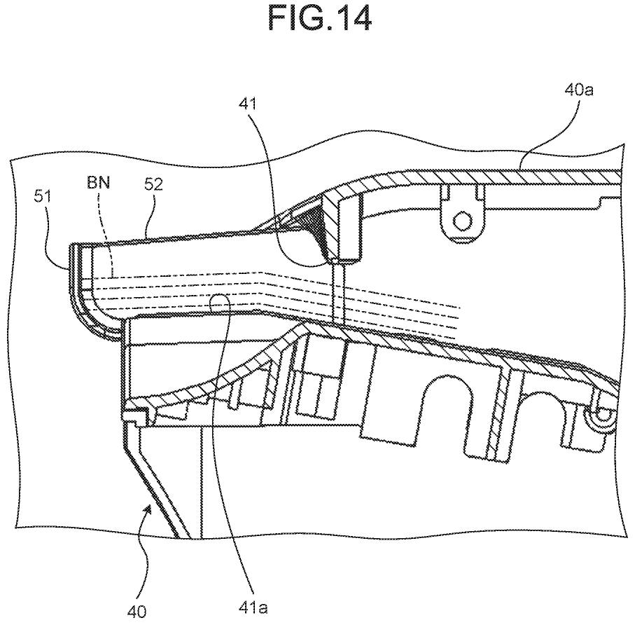

Next, the operation of the bill processing machine 40 will be described. The bill deposited into the bill receiving port 41 is detected by a detection sensor, which is not illustrated, of the money receiving unit 44. Then, the bill is conveyed to the discrimination unit 46 by the bill conveying mechanism 48 driven by the cash control unit 60. When a bill is jammed during the conveyance, or when the discrimination unit 46 cannot sufficiently determine the bill, the bill conveying mechanism 48 temporarily returns the bill to the bill receiving port 41 via the money receiving unit 44. In this example, the bottom part 41a that configures the bill receiving port 41 projects forward with respect to the bill receiving port 41, and the upward extending part 51 of the bill guide 50 extends upward from the front end portion of the bottom part 41a. Consequently, as illustrated in FIG. 14, a bill BN that has temporarily been returned to the bill receiving port 41 can be placed on the bottom part 41a while abutting to the upward extending part 51.

Moreover, when the discrimination unit 46 determines that the bill is not a genuine bill, the bill conveying mechanism 48 delivers the bill to the money payment unit 45, and dispenses the bill from the bill payment port 42. On the other hand, when the discrimination unit 46 determines that the bill is a genuine bill, the bill conveying mechanism 48 stores the bill according to the denomination in the bill storage chamber 47.

Alternatively, when a dispense command is supplied from the POS register device PR, the cash control unit 60 causes the bill of corresponding denomination to deliver to the bill conveying mechanism 48 from the bill storage chamber 47, causes the bill conveying mechanism 48 to convey the bill to the money payment unit 45, and pays the bill from the bill payment port 42.

As described above, with the money processing apparatus 1 of the embodiment, when the number of coins stored in the coin storage chamber 24 is equal to or more than a predetermined number of coins, and overflow is generated in the coin storage chamber 24, the cash control unit 60 conveys a predetermined number of coins from the coin storage chamber 24 to the temporary holding unit 22, and discharges the coins to the outside from the coin storage chamber 24 through the coin discharge passage 33, under a condition that a discharge command of the predetermined number of coins from the coin storage chamber 24 is supplied from the POS register device PR. Consequently, it is possible to prevent the loss of a settlement opportunity caused by the generation of overflow.

Moreover, the coin discharge passage 33 is provided so as to be branched from the branch point 31a placed in the midway of the coin return passage 31. Consequently, it is possible to alternately switch the coin return and discharge gate 35 between the first state and the second state, and discharge the coin by passing the coin through the coin discharge passage 33 after passing through a part of the coin return passage 31. Moreover, by sharing a part of components and by reducing the number of components, it is possible to reduce the manufacturing cost and save space.

With the money processing apparatus 1 described above, the passing speed of the coin in the detection area 39 of the count detecting unit 37 is greater than the passing speed of the coin at the unit inlet 30a placed immediately before the detection area 39. Thus, even when the conveyance unit conveys the coins from the temporary holding unit 22 to the unit inlet 30a one by one in a linked manner, it is possible to pass the coins through the detection area 39 in a state that the coins are separated from each other. Consequently, it is possible to favorably detect the number of coins to be conveyed.

Moreover, with the money processing apparatus 1 described above, the bottom part 41a that configures the bill receiving port 41 is formed so as to project forward with respect to the bill receiving port 41. Consequently, the bill guide 50 can favorably align the posture of the bill, with the upward extending part 51, which is provided so as to extend upward from the front end portion of the bottom part 41a, being abutted to the bill returned to the bill receiving port 41 by the bill conveying mechanism 48.

In particular, when the projection distance of the bottom part 41a projecting forward from the bill receiving port 41 is sufficiently secured, it is possible to pull out forward the bill returned to the bill receiving port 41 from the bill receiving port 41. Consequently, there is no risk of obstructing the bill sent to the bill payment port 42 by the bill conveying mechanism 48.

Moreover, in the bill guide 50 described above, the notch 51a is formed on the center portion of the upward extending part 51 in the horizontal direction. Consequently, it is possible to easily deposit the bill to the bill receiving port 41 and easily take out the bill returned to the bill receiving port 41. Thus, it is possible to improve the convenience.

Furthermore, the side extending part 52 that continues to the right end part and the left end part of the upward extending part 51 is provided so as to project upward from the right end portion and the left end portion of the bottom part 41a. Consequently, the bill guide 50 described above can favorably align the posture of the bill, with the side extending part 52 being abutted to the bill returned to the bill receiving port 41.

Still furthermore, the substrate 54, the upper surface and the lower surface of which are mounted with the LEDs 53a and 53b, is mounted on the portion that divides the money receiving unit 44 and the money payment unit 45 in the bill processing machine 40. The LED 53a provided on the upper surface of the substrate 54 illuminates the edge portion including the bill guide 50, and the LED 53b provided on the lower surface of the substrate 54 illuminates the bill payment port 42. Consequently, while sharing the light source members and saving space, it is possible to illuminate the bill at the bill payment port 42.

In this manner, the embodiment has been described. However, the present disclosure is not limited to the embodiment, and various modifications may also be made.

In the embodiment described above, the coin return and discharge unit 30 is provided inside the coin processing machine main body 10a. However, in the present disclosure, the coin return passage and the coin discharge passage that configure the coin return and discharge unit may be opened by opening the opening formed on the side surface of the coin processing machine main body 10a through a door body. With such a configuration, even when a coin is jammed in the coin return passage and the coin discharge passage, it is possible to remove the coin that has caused the jam by opening the opening.

In the embodiment described above, the substrate 54 provided with the LEDs 53a and 53b is mounted on the portion that divides the money receiving unit 44 and the money payment unit 45 of the bill processing machine 40. In the present disclosure, a plate-shaped member the upper surface and the lower surface of which are each provided with an LED serving as a light source, may also be mounted on the portion that divides the coin deposit port and the coin return port in the coin processing machine. Consequently, it is possible to illuminate the coin dispensed to the coin return port, while illuminating the surrounding part of the coin deposit port.

In the embodiment described above, the passing speed of the coin that passes through the detection area 39 of the count detecting unit 37 in the coin return and discharge unit 30 is greater than the passing speed of the coin at the unit inlet 30a placed immediately before the detection area 39. In the present disclosure, the above-described configuration is applicable to various units, in addition to the coin return and discharge unit.

The present disclosure includes a conveyance unit that conveys a plurality of coins one by one so that the coins do not overlap with each other, and a count detecting unit that detects the number of coins conveyed by the conveyance unit. The present disclosure is configured such that the passing speed of the coin in the detection area of the count detecting unit is greater than the passing speed of the coin immediately before the detection area. Consequently, even when the conveyance unit conveys the coins one by one in a manner like a string of beads, it is possible to let the coins separately pass through the detection area one by one. Consequently, it is possible to favorably detect the number of coins to be conveyed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A money processing apparatus comprising:
a coin sorter configured to sort a received coin by denominations;
coin storages each provided for each denomination, each of the coin storages being configured to store the coin sorted by the coin sorter and deliver the coin in accordance with a payment instruction;
a conveyor configured to convey coins one by one such that the coins do not overlap with each other; and
a count detector configured to detect the number of coins conveyed by the conveyor, wherein
a passing speed of the coin in a detection area of the count detector is greater than a passing speed of the coin immediately before the detection area of the count detector.

2. The money processing apparatus according to claim 1, wherein the conveyor conveys the coin in a posture in which a center axis of the coin is substantially perpendicular to a conveying direction.

3. The money processing apparatus according to claim 1, wherein the detection area is configured so as to gradually incline downward toward a downstream side in the conveying direction.

4. The money processing apparatus according to claim 2, wherein the detection area is configured so as to gradually incline downward toward a downstream side in the conveying direction.

5. The money processing apparatus according to claim 1, wherein the passing speed of the coin immediately before the detection area of the count detector is speed after the coin comes into contact with a wall surface forming a conveyance passage and changes a direction of the coin.

6. The money processing apparatus according to claim 2, wherein the passing speed of the coin immediately before the detection area of the count detector is speed after the coin comes into contact with a wall surface forming a conveyance passage and changes a direction of the coin.

7. The money processing apparatus according to claim 3, wherein the passing speed of the coin immediately before the detection area of the count detector is speed after the coin comes into contact with a wall surface forming a conveyance passage and changes a direction of the coin.

8. The money processing apparatus according to claim 4, wherein the passing speed of the coin immediately before the detection area of the count detector is speed after the coin comes into contact with a wall surface forming a conveyance passage and changes a direction of the coin.
